(19) United States
(12) Patent Application Publication
(10) Pub. No.: US 2010/0282351 A1
(43) Pub. Date: Nov. 11, 2010

(54) Pipe-lining material and pipeline lining method

(75) Inventors: Takao Kamiyama, Hiratsuka-shi (JP); Koji Kaneta, Hiratsuka-shi (JP); Kenji Fujii, Hiratsuka-shi (JP); Fuminori Tanaka, Hiratsuka-shi (JP)

Correspondence Address: BRUCE L. ADAMS, ESQ.;ADAMS & WILKS, SUITE 1231, 17 BATTERY PLACE, NEW YORK, NY, 10004, US

(73) Assignee: SHONAN GOSEI-JUSHI SEISAKUSHO K.K.

(21) Appl. No.: 12/800,018

(22) Filed: May 6, 2010

(30) Foreign Application Priority Data
May 8, 2009 (JP) 2009-113125

(51) Int. Cl. F16L 55/165; F16L 11/12

(52) U.S. Cl. 138/98; 138/97; 405/150.1; 405/184.2

(57) ABSTRACT

A flexible tubular pipe-lining material impregnated with a thermosetting resin is sandwiched by sandwiching steel belts in order to impart elasticity and rigidity thereto. A leading steel belt for leading the pipe-lining material is fixedly attached to the distal end thereof and the sandwiching steel belts. A drawing steel belt is removably attached to the leading steel belt to draw the pipe-lining material into a pipeline to be repaired. Additionally, an auxiliary steel belt is attached to the pipe-lining material to support the insertion thereof into the pipeline. The pipe-lining material can be inserted into the pipeline by the sandwiching steel belts, the drawing steel belt and the auxiliary steel belt. Such an arrangement allows the pipe-lining material to be easily and smoothly inserted into the pipeline even where there is a plurality of sections bent at a right angle or close to a right angle.

### BACKGROUND OF THE INVENTION

1. Field of the Invention

The present invention relates to a pipe-lining material used to line pipelines in order to repair an aged pipeline, and to a pipeline lining method using the same.

2. Description of the Prior Art

When a communications pipe, gas pipe, sewer pipe, water pipe, electrical pipe, or other pipeline buried under ground has aged, pipeline lining methods are carried out to repair a pipe in the pipeline without the pipe being removed from the ground. In such pipeline lining methods, a tubular pipe-lining material impregnated with a thermosetting resin is inserted into the pipeline by everting or drawing-in. The pipe-lining material is expanded by compressed air and pressed against an inner peripheral surface of the pipeline. In this sate, the pipe-lining material is heated to cure the thermosetting resin thereof in order to line the pipeline (e.g., Japanese Laid-open Patent Application No. 2006-123547).

There are typically two methods of inserting a pipe-lining material into a pipeline. In one method, the pip-lining material is everted by compressed air for insertion into the pipeline. In the other method, the pipe-lining material is previously everted and inserted into a highly airtight tube, and the pipe-lining material together therewith is drawn in and inserted into the pipeline.

However, in the conventional insertion method for a pipe-lining material, insertion into pipelines is extremely difficult in sections that are bent at a right angle or close to a right angle. Specifically, with the method in which the material is pushed in while being everted, the eversion does not occur in the sections bent at a right angle or close to a right angle. Furthermore, with a drawing-in method, the contact resistance of the pipe-lining material increases as the bent sections increase, and the pipe-lining material therefore becomes heavier and is unable to be drawn in. If drawing-in continues forcibly, the pipe-lining material is stretched and damaged, which dramatically reduces the quality of the pipe-lining material.

An object of the present invention is to provide a pipe-lining material capable of being easily and smoothly inserted into a pipeline even where there is a plurality of sections bent at a right angle or close to a right angle, and to provide a pipeline lining method using the same.

### SUMMARY OF THE INVENTION

According to the present invention, a flexible tubular pipe-lining material is provided that is impregnated with a curable resin and inserted into a pipeline to repair the inner wall thereof. The pipe-lining material includes sandwiching belt members each having elasticity and rigidity for sandwiching the pipe-lining material therebetween; a leading belt member fixedly attached to the sandwiching belt members and the pipe-lining material; and a drawing belt member detachably connected to the leading belt member.

According to a pipeline lining method, a flexible tubular pipe-lining material is used that is impregnated with a curable resin and inserted into a pipeline to repair the inner wall thereof. The method comprises preparing a belted pipe-lining material comprising the pipe-lining material, sandwiching belt members each having elasticity and rigidity for sandwiching the pipe-lining material therebetween, and a leading belt member fixedly attached to the sandwiching belt members and the pipe-lining material, the belted pipe-lining material being transported at an insertion end of the pipeline from which the belted pipe-material is inserted; guiding a drawing belt member to the insertion end of the pipeline from a drawing end of the pipeline from which the drawing belt member is drawn in; the drawing belt member being coupled to the leading belt member of the belted pipe-lining material prepared at the insertion end of the pipeline; drawing in the drawing belt member from the drawing end of the pipeline in order to insert the belted lining material into the pipeline; removing the sandwiching belt members, the leading belt member, and the drawing belt member from the pipeline with the pipe-lining material caused to remain inside the pipeline; subjecting the pipe-lining material to pressure to cause it to expand against an inner peripheral surface of the pipeline; and heating the pipe-lining material to cause the curable resin to be cured to line the pipeline.

According to the present invention, the pipe-lining material is led and drawn into the pipeline by belt members each having elasticity and rigidity, so that the pipe-lining material can be easily and smoothly inserted into the pipeline even where there is a plurality of sections bent at a right angle or close to a right angle, and it is possible to prevent the pipe-lining material from being stretched and damaged by forcible insertion. This makes it possible to make the lining work time reduced.

Furthermore, the elastic and rigid belt members are attached to the sides of the pipe-lining material. This allows the pipe-lining material to be protected by the belt members during insertion, making it possible to prevent damage to the lining.

Further features of the invention, its nature and various advantages will be more apparent from the accompanying drawings and following detailed description of the invention.

### BRIEF DESCRIPTION OF THE DRAWINGS

FIG. 1 is a cross-sectional view showing a pipe-lining material that is inserted into a pipeline to be repaired;

FIG. 2 is a schematic perspective view showing a pipe-lining material that is fabricated by everting and inserting the pipe-lining material in FIG. 1 into a highly airtight tube;

FIG. 3 is a cross-sectional view showing the pipe-lining material in FIG. 2 that is folded into the shape of an H and bound with a tape;

FIG. 4 is a cross-sectional view showing the pipe-lining material to which steel belts are attached;

FIG. 5 is a side view showing the pipe-lining material to which steel belts are attached;

FIG. 6a is a side view showing an entire belted pipe-lining material;

FIG. 6b is a top view showing an entire belted pipe-lining material;

FIG. 7a is a cross-sectional view along the line B-B in FIG. 6a;

FIG. 7b is a cross-sectional view along the line C-C in FIG. 6a;

FIG. 8 is an illustrative view showing a state in which a drawing belt is carried in the pipeline in order to draw the belted pipe-lining material into the pipeline;

FIG. 9 is an illustrative view showing a state in which the drawing belt is used to draw in the belted pipe-lining material into the pipeline;

FIG. 10 is an illustrative view showing a belted pipe-lining material to which a drawing steel belt and an auxiliary steel belt are attached;

FIG. 11 is an illustrative view showing a state in which the drawing steel belt and the auxiliary steel belt are carried into the pipeline;

FIG. 12 is an illustrative view showing a state in which the drawing steel belt and the auxiliary steel belt are attached to the belted pipe-lining material;

FIG. 13 is an illustrative view showing a state in which the drawing steel belt and the auxiliary steel belt are used to draw in the belted pipe-lining material into the pipeline;

FIG. 14 is an illustrative view showing a state in which the belted pipe-lining material has been drawn in;

FIG. 15 is an illustrative view showing a state in which a pipe-lining material with its end made open is expanded to line the pipeline; and

FIG. 16 is an illustrative view showing a state in which a pipe-lining material with its end made closed is expanded to line the pipeline.

### DESCRIPTION OF THE PREFERRED EMBODIMENTS

The present invention will now be described in detail with reference to the embodiments shown in the accompanying drawings. Described are pipelines such as sewers, communication conduits, gas lines, agricultural pipelines and the like each having a plurality of bent sections.

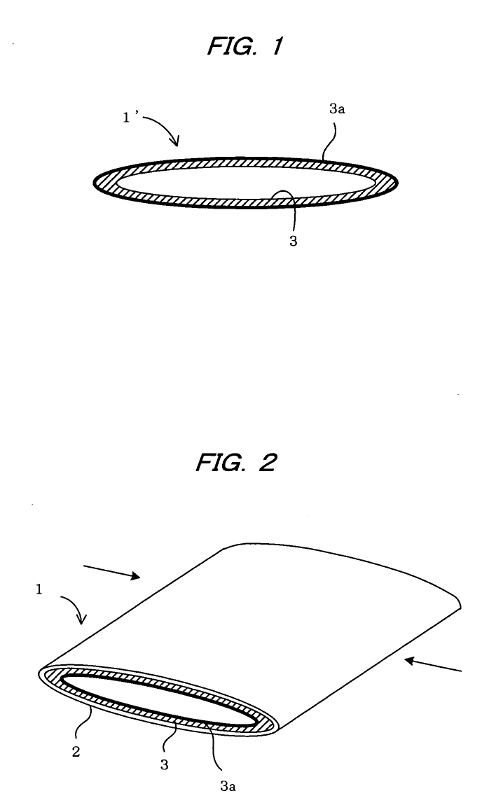

FIG. 1 shows a pipe-lining material used to repair pipelines. The pipe-lining material 1′ is a flexible tubular lining material comprising a flexible tubular resin-absorbing material 3 whose exterior surface is coated (heat-fused) with a highly airtight plastic film 3a of polyethylene, polypropylene, polyamide, vinyl chloride or the like.

The tubular resin-absorbing material 3 is composed of a non-woven or woven fabric or a mat made of plastic fiber of polyamide, polyester, polypropylene, or the like; a woven fabric or a mat made of glass fiber; or a non-woven or woven fabric or a mat that combines the use of the above-mentioned plastic fiber and glass fiber. The tubular resin-absorbing material 3 is impregnated with an uncured liquid thermosetting or photo-curing resin such as unsaturated polyester resin, vinyl ester resin, epoxy resin, or the like.

FIG. 2 shows a pipe-lining material 1 to be drawn in, which is fabricated by everting and inserting the pipe-lining material 1′ into a highly airtight tube 2 of the same material as the plastic film 3a.

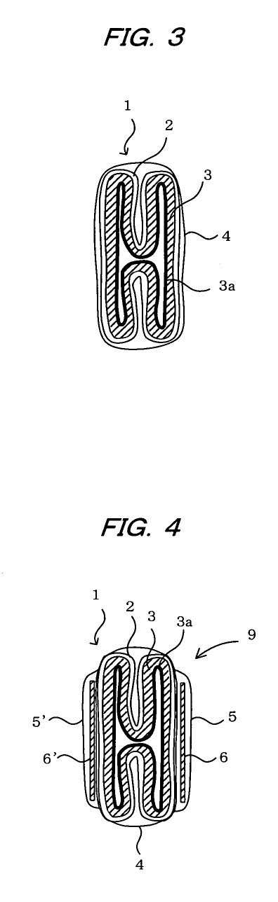

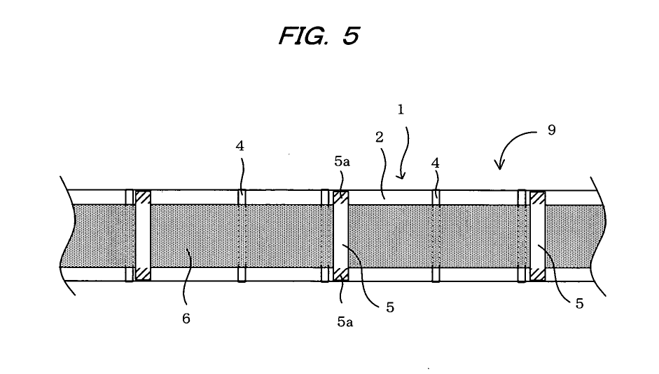

In the present embodiment, the pipe-lining material 1 is folded and bound with a tape 4 so as to provide a reduced width, as shown in FIGS. 3 to 7, and steel belts 6 and 6′ for sandwiching the pipe-lining material 1 from both sides are removably attached to provide a steel-belted pipe-lining material 9 (hereafter abbreviated as belted pipe-lining material), which is inserted into the pipeline in order to repair the pipeline.

The sandwiching steel belts 6 and 6′ are elastic and rigid metallic belt members, impart elasticity and rigidity to the pipe-lining material 1, and reinforce the trunk of the pipe-lining material 1. The steel belts 6 and 6′ also partially cover and protect the pipe-lining material 1. The sandwiching steel belts 6 and 6′ are composed of a thin steel plate, but belt members having elasticity and rigidity may be composed of steel wires that are bundled together and covered with rubber and the like.

To fabricate the belted pipe-lining material 9, the pipe-lining material 1 is pushed from both sides, as shown by arrows in FIG. 2, and folded as shown in FIG. 3 so that the cross section is in the shape of an H. Next, as shown in FIGS. 3 to 6, a tape 4 such as cellophane tape is wound around the folded pipe-lining material 1 at a suitable interval of approximately several tens of centimeters in the lengthwise direction of the pipe-lining material 1. It is acceptable to bind the pipe-lining material with a string or other member instead of the tape 4.

Folding the pipe-lining material 1 is not limited to the shape of an H, and any shape is acceptable as long as the material becomes narrow and easily extends when made to expand into a cylindrical shape upon application of pressure after the pipe-lining material 1 has been inserted into the pipeline.

Next, as shown in FIGS. 4 to 6, belt loops 5 and 5′ are attached by heat-fusing or using an adhesive on both sides in the lengthwise direction of the folded pipe-lining material 1 at suitable intervals. The belt loops 5 and 5′ serve to guide the sandwiching steel belt 6 and 6′ therethrough with some space maintained and to prevent the steel belts 6 and 6′ from shifting significantly from the pipe-lining material 1. The belt loops 5 and 5′ are formed in a strip from a film such as polyethylene and the like.

The belt loop 5 and 5′ may first be attached to the highly airtight tube 2, and the pipe-lining material 1′ in FIG. 1 can be everted and inserted into the highly airtight tube 2.

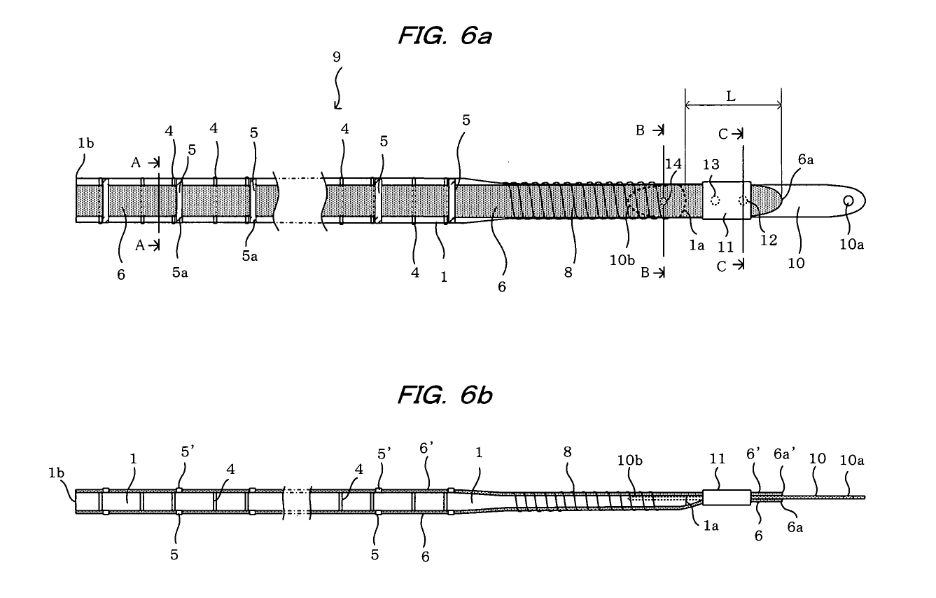

The pipe-lining material 1 is made open at one end la shown in FIGS. 6a and 6b, and made open or closed airtightly at the other end lb.

Next, the steel belts 6 and 6′ that are as long as or a little longer than the pipe-lining material 1 are inserted into the belt loops 5 and 5′ so as to sandwich the pipe-lining material 1 therebetween. The belt loops 5, 5 may first be attached to the highly airtight tube 2, and the steel belts 6, 6′ may then be inserted into the belt loops 5 and 5′. Subsequently, the pipe-lining material in FIG. 1 can be everted and inserted into the airtight tube 2.

As shown in FIGS. 6a and 6b, the sandwiching steel belts 6, 6′ are longer by L than the distal end la of the pipe-lining material 1. A leading steel belt 10, which is so elastic, rigid and wide as the sandwiching steel belts, are inserted into the distal open ends 6a, 6a′ thereof in order to lead the pipe-lining material 1.

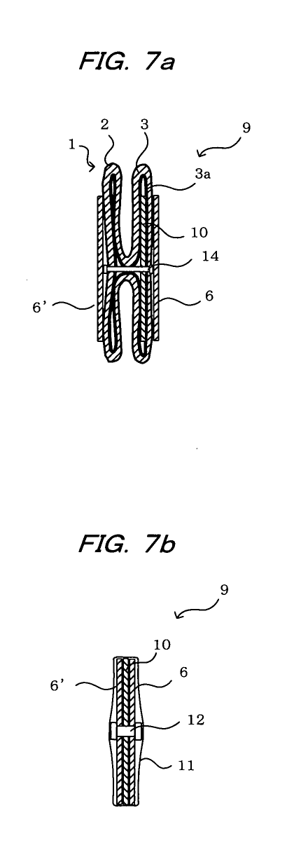

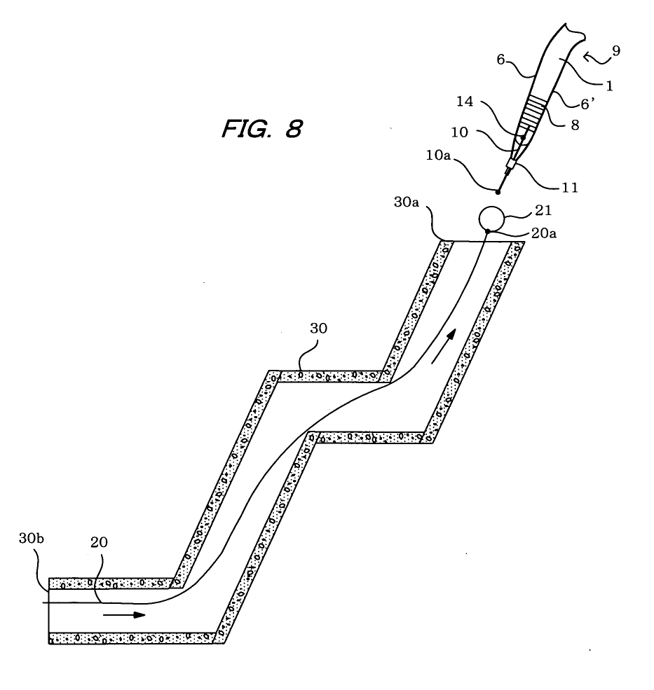

FIG. 4, FIGS. 7a and 7b show cross-sectional views along lines A-A, B-B and C-C, respectively.

The leading steel belt 10 has a connection hole 10a at one end, and the other end 10b thereof is inserted between the sandwiching steel belts 6, 6′ and into the distal end of the pipe-lining material 1. The leading steel belt 10 is fixed to the pipe-lining material 1 with a rivet 14 or other coupling implements, as shown in FIG. 7a.

The sandwiching steel belts 6 and 6′ extend to the substantial center of the leading steel belt 10, and are fixed to the leading steel belt 10 in the center thereof via rivets 12, 13 or other such coupling implements (FIG. 7b). The rivets 12, 13 are covered using a plastic tape 11 having a smooth surface in order to prevent the rivets 12, 13 from coming into contact with the inner wall of a pipeline and failing to be smoothly drawn in when the pipe-lining material 1 is inserted into a pipeline. Since the leading steel belt 10 and the sandwiching steel belts 6, 6′ are coupled by rivets or the like, the coupled portions can be prevented from losing elasticity in comparison with coupling using welding or another method.

The sandwiching steel belts 6, 6′ are bound to the tip end portion of the pipe-lining material 1 with a strong thread 8, and the pipe-lining material 1 and the sandwiching steel belts 6, 6′ are tied to each other so as to not separate.

The belt loops 5 and 5′ can be attached to the pipe-lining material 1 from the top of the sandwiching steel belts 6 and 6′ after the sandwiching steel belts 6, 6′ have been fixed to the leading steel belt 10 and the pipe-lining material 1.

The belted pipe-lining material includes a pipe-lining material to which the sandwiching steel belts and the leading steel belt are attached.

A method will next be described which uses a thus fabricated belted pipe-lining material to repair and rehabilitate an aged pipeline.

As shown in FIG. 8, the belted pipe-lining material 9 is prepared and positioned at the insertion end 30a of a pipeline 30. An air ball 21 such as a balloon that is fixed to the distal end 20a of a drawing belt 20 is carried by compressed air from the drawing end 30b of the pipeline 30 through the pipeline 30 up to the insertion end 30a thereof. When the air ball 21 appears at the insertion end 30a of the pipeline 30, it is separated from the drawing belt 20, and the distal end 20a of the drawing belt 20 is connected to the connection hole 10a of the leading steel belt 10 of the belted lining material 9.

The drawing belt 20 is towed from the drawing end 30b of the pipeline 30 using a winch (not shown). The belted pipe-lining material 9 attached to the drawing belt 20 is then led by the leading steel belt 10 and drawn in toward the drawing end 30b of the pipeline 30.

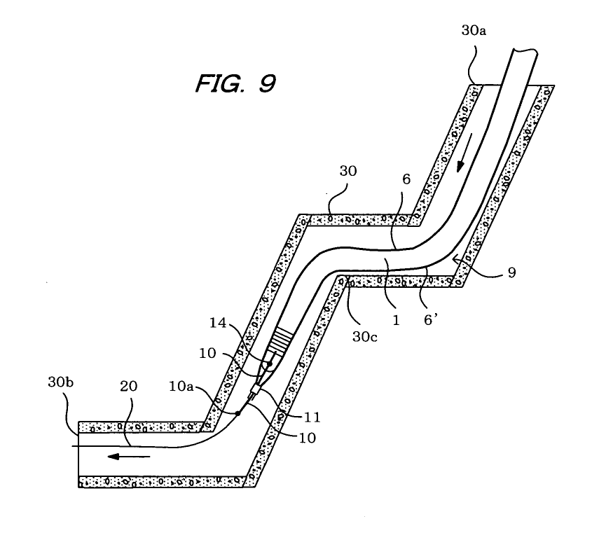

To avoid the complexity in the drawings, the belted pipe-lining material 9 is shown in FIGS. 8 and 9 and in the following drawings with the tape 4, the belt loops 5, 5′ and the like omitted therefrom, and the coupled portions are also shown as simplified black spots.

Compared to the simple pipe-lining material, the sandwiching steel belts 6 and 6′ impart elasticity and rigidity to the pipe-lining material, and reinforce the trunk thereof. Furthermore, the belted lining material 9 can be led through the pipeline 30 by the leading steel belt 10 that is so elastic and rigid as the sandwiching steel belts 6, 6′.

Even if there is a plurality of locations that are bent at a right angle or close to a right angle in the pipeline 30, the contact resistance of the belted pipe-lining material 9 is low, and the belted pipe-lining material 9 can be easily and smoothly inserted, thus allowing the time required for lining work to be reduced. Also, since the contact resistance is low and the sandwiching steel belts 6 and 6′ protects the pipe-lining material 1, it is possible to prevent the pipe-lining material 1 from being unduly stretched and damaged.

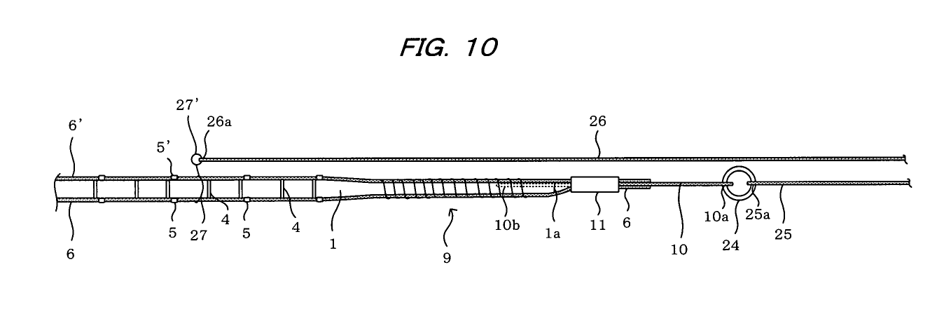

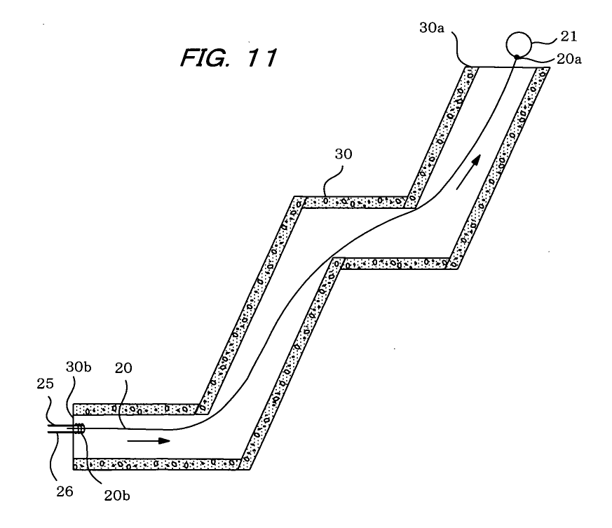

FIG. 10 shows another embodiment in which the belted lining material 9 can be drawn in more reliably. In this embodiment, instead of the drawing belt 20, a drawing steel belt 25 is used which is detachably connected to the leading steel belt 10 using a hook-joint 24. Additionally, an auxiliary steel belt 26 is attached to the belted lining material 9 using a rope (or hose band) 27 and a coupler 27′. The rope (or hose-band) 27 is wound around the belted lining material 9 so as not to be shifted, and has its end connected to the coupler 27′.

The drawing steel belt 25 and the auxiliary steel belt 26 are the same as or more than the sandwiching steel belts 6, 6′ in width, elasticity and rigidity. The drawing steel belt 25 is made longer than a pipeline to be repaired, and the auxiliary steel belt 26 is made loner than the drawing steel belt 25 by a distance between the joint 24 and the rope 27. A connection hole 25a for connection with the joint 24 is formed at one end of the drawing steel belt 25. Formed also at one end of the auxiliary steel belt 26 is a connection hole 26a through which the auxiliary steel belt 26 is coupled to the coupler 27′.

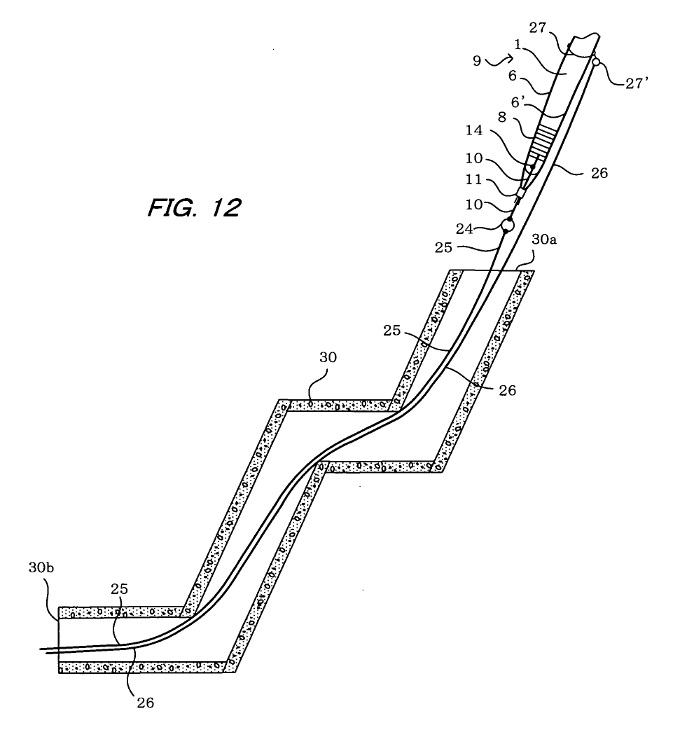

When a pipeline is to be lined using the belted pipe-lining material 9 as described above, the air ball 21 is attached to one end 20a of the drawing belt 20, and the drawing steel belt 25 and the auxiliary steel belt 26 are attached to the other end 20b thereof. As shown in FIG. 11, the air ball 21 is carried by compressed air from the drawing end 30b of the pipeline 30 through the pipeline 30 to the insertion end 30a thereof. When the air ball 21 and the distal end 20a of the drawing belt 20 appear outside the pipeline 30, the drawing belt 20 is pulled so that the drawing steel belt 25 and the auxiliary steel belt 26 can be carried from the drawing end 30 of the pipeline 30 to the insertion end 30b thereof. When the drawing steel belt 25 and the auxiliary steel belt 26 appear outside the pipeline 30, the drawing belt 20 is removed, and the drawing steel belt 25 is connected via the joint 24 to the leading steel belt 10 of the belted pipe-lining material 9, as shown in FIG. 12. The auxiliary steel belt 26 is also coupled to the belted pipe-lining material 9 via the rope (hose band) 27 and the coupler 27′.

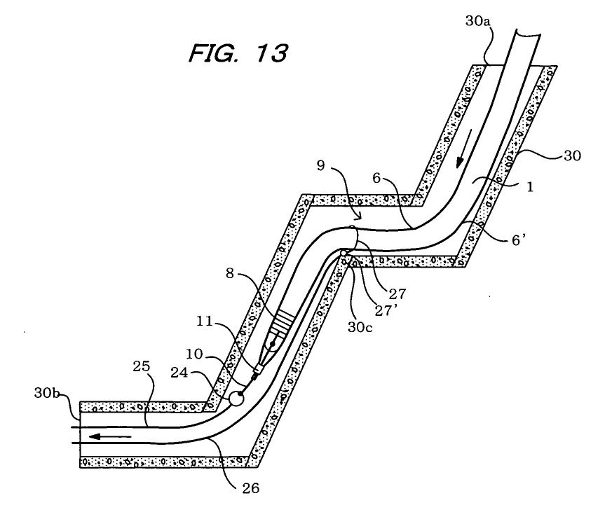

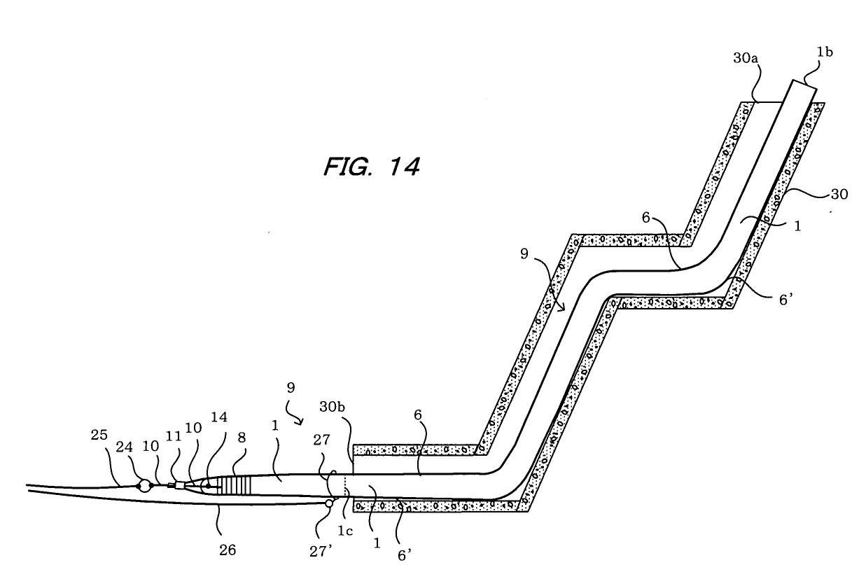

When the drawing steel belt 25 and the auxiliary steel belt 26 are towed using a winch, the drawing steel belt 25, the auxiliary steel belt 26 and the belted pipe lining material 9 attached thereto are drawn in from the insertion end 30a of the pipeline 30 toward the drawing end 30b thereof, as shown in FIG. 13.

The drawing steel belt 25 and the auxiliary steel belt 26 the same as or more than the sandwiching steel belts 6, 6′ in elasticity and rigidity lead the pipe-lining material 9 and cause it to pass through the pipeline 30. Since the drawing steel belt 25 and the auxiliary steel belt 26 are more elastic and rigid than the drawing belt 20 in FIG. 9, the belted pipe-lining material 9 can be led more reliably even if there is a plurality of locations that are bent at a right angle or close to a right angle in the pipeline 30.

If, for example, there is a bent portion 30c in the pipeline 30 as shown in FIG. 13, the contact resistance of the belted pipe-lining material 9 becomes great, making it difficult to draw in the belted pipe-lining material. In such a situation, pulling the auxiliary steel belt 26 forcibly causes the contact resistance to be overcome and allows the belted pipe-lining material 9 to be smoothly inserted into the pipeline. Since the bent portion 30c in the pipeline 30 can be predicted in advance, the position at which the rope 27 is attached to the belted pipe-lining material 9 can be shifted accordingly. This ensures that the pipe-lining material can be inserted more smoothly into the pipeline, thus allowing the time required for lining work to be reduced. Also, since the contact resistance is low and the sandwiching steel belts 6 and 6′ protects the pipe-lining material 1, it is possible to prevent the pipe-lining material 1 from being unduly stretched and damaged.

The auxiliary steel belt 25 may be omitted, depending upon how much the pipeline is bent.

After the belted pipe-lining material 9 has been inserted (drawn in) into the pipeline 30, as shown in FIG. 14, the drawing steel belt 25 and the auxiliary steel belt 26 are removed. The string 8 at the distal end of the belted pipe-lining material 9 is cut off to disconnect the sandwiching steel belts 6, 6′ from the distal end thereof. The pipe-lining material 1 is further cut off at the section 1c thereof in order to disconnect the pipe-lining material 1 from the leading steel belt 10. Pulling the leading steel belt 10 causes the sandwiching steel belts 6, 6′ connected thereto to be released from the belt loops 5, 5 and to be removed from the pipe-lining material 1 while the pipe-lining material 1 remains inside the pipeline 30.

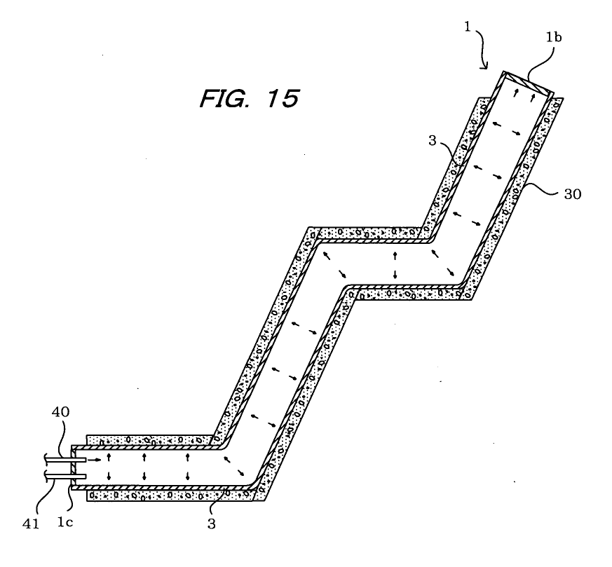

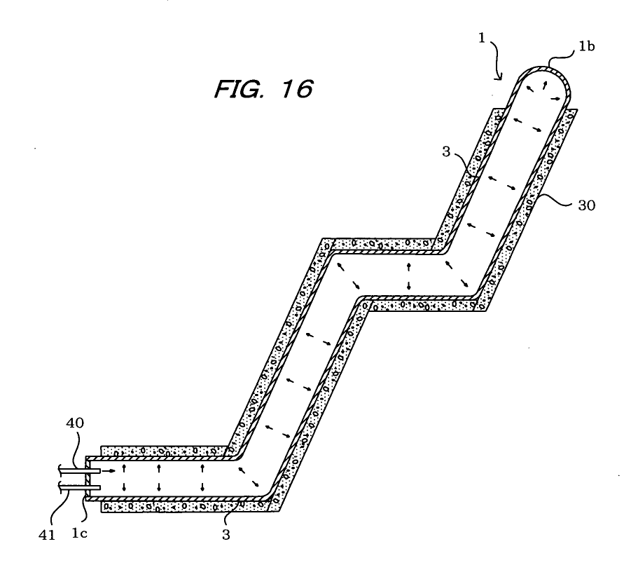

In cases in which the pipe-lining material 1 is open at the end 1b thereof, the pipe-lining material 1 is sealed airtightly at the end 1b and the cut-off section 1c, as shown in FIG. 15, and compressed air is supplied thereto from an air hose 40. In cases in which the pipe-lining material 1 is closed at the end 1b, the pipe-lining material 1 is sealed airtightly at the cut-off section 1c, as shown in FIG. 16, and compressed air is supplied thereto from the air hose 40.

The pipe-lining material 1 is caused to expand via application of compressed air from the inside, and the tape 4 that restrained the pipe-lining material 1 is cut off. This causes the pipe-lining material 1 to expand into a cylindrical shape and to be pressed against the inner peripheral surface of the pipeline. In this state, a hot water shower or steam is supplied to the pipe-lining material 1 via a hot water/steam hose 41. The thermosetting resin impregnated into the resin absorbing material 3 of the pipe-lining material 1 is cured, and the pipeline 30 is lined by the pipe-lining material 1. The pipe-lining material 1 extending excessively outside the pipeline 30 will be cut off and removed by suitable means.

According to the embodiment as described above, the sandwiching steel belts 6 and 6′ are attached across the entire length of the pipe-lining material 1, but can be attached across a portion of the entire length of the pipe-lining material 1.

In the embodiment, two steel belts 6 and 6′ are attached so as to sandwich the pipe-lining material 1, but it is acceptable to attach only one belt to one side of the pipe-lining material 1. It is also acceptable to attach three or more belts so as to enclose the pipe-lining material 1.

Furthermore, instead of the steel belt, another elastic and rigid belt member composed of a non-steel metal, plastic, or other material can be attached to the pipe-lining material 1.

The pipe-lining material of the present invention can be used not only as a lining for a communications pipe, gas pipe, sewer pipe, water pipe, electrical pipe, or other subterranean pipeline, but also as a lining for a communications pipe, gas pipe, sewer pipe, water pipe, electrical pipe, or other pipeline inside apartment buildings, office buildings, and other buildings.

What is claimed is:

1. A flexible tubular pipe-lining material that is impregnated with a curable resin and inserted into a pipeline to repair the inner wall thereof, the pipe-lining material including:
sandwiching belt members each having elasticity and rigidity for sandwiching the pipe-lining material therebetween;
a leading belt member fixedly attached to the sandwiching belt members and the pipe-lining material; and
a drawing belt member detachably connected to the leading belt member.

2. A pipe-lining material according to claim 1, wherein the leading belt member and the drawing belt member have elasticity and rigidity similar to that of the sandwiching belt members.

3. A pipe-lining material according to claim 1, wherein an auxiliary belt member for supporting the insertion of the pipe-lining material is removably attached to the pipe-lining material.

4. A pipe-lining material according to claim 1, wherein the pipe-lining material is folded and sandwiched by the sandwiching belt members.

5. A pipe-lining material according to claim 1, wherein the sandwiching belt members are made of a steel belt.

6. A pipe-lining material according to claim 2, wherein the leading belt member and the drawing belt member are made of a steel belt, respectively.

7. A pipe-lining material according to claim 3, wherein the auxiliary belt members is made of a steel belt.

8. A pipeline lining method using a flexible tubular pipe-lining material that is impregnated with a curable resin and inserted into a pipeline to repair the inner wall thereof, comprising:
preparing a belted pipe-lining material comprising the pipe-lining material, sandwiching belt members each having elasticity and rigidity for sandwiching the pipe-lining material therebetween, and a leading belt member fixedly attached to the sandwiching belt members and the pipe-lining material, the belted pipe-lining material being transported at an insertion end of the pipeline from which the belted pipe-material is inserted;
guiding a drawing belt member to the insertion end of the pipeline from a drawing end of the pipeline from which the drawing belt member is drawn in; the drawing belt member being coupled to the leading belt member of the belted pipe-lining material prepared at the insertion end of the pipeline;
drawing in the drawing belt member from the drawing end of the pipeline in order to insert the belted lining material into the pipeline;
removing the sandwiching belt members, the leading belt member, and the drawing belt member from the pipeline with the pipe-lining material caused to remain inside the pipeline;
subjecting the pipe-lining material to pressure to cause it to expand against an inner peripheral surface of the pipeline; and
heating the pipe-lining material to cause the curable resin to be cured to line the pipeline.

9. A pipeline lining method according to claim 8, wherein an auxiliary belt member for supporting the insertion of the pipe-lining material is removably attached to the pipe-lining material.

10. A pipeline lining method according to claim 8, wherein the pipe-lining material is folded and sandwiched by the sandwiching belt members.

11. A pipeline lining material according to claim 8, wherein the sandwiching belt members, the leading belt member and the drawing belt member are made of a steel belt, respectively.

12. A pipeline lining material according to claim 9, wherein the auxiliary belt members is made of a steel belt.
